(19) United States
(12) Patent Application Publication
(10) Pub. No.: US 2014/0264094 A1
(43) Pub. Date: Sep. 18, 2014

(54) GONADAL SHIELD

(71) Applicants: Richard M. Heller, Nashville, TN (US); Christie M. Cottongim, Bowling Green, KY (US)

(72) Inventors: Richard M. Heller, Nashville, TN (US); Christie M. Cottongim, Bowling Green, KY (US)

(21) Appl. No.: 14/211,592

(22) Filed: Mar. 14, 2014

Related U.S. Application Data
(60) Provisional application No. 61/782,289, filed on Mar. 14, 2013.

(51) Int. Cl. G21F 3/00

(52) U.S. Cl. CPC G21F 3/00
USPC 250/515.1

(57) ABSTRACT

A gonadal shield for shielding at least a portion of radiation emitted during an x-ray procedure from the gonads of the patient is provided. The gonadal shield comprises a radiopaque protective cover and a radiolucent handle attached to the cover and extending away from the cover radially and/or axially. A plate attached to the handle can be removably attached to the protective cover to allow for selective and removable attachment with the protective cover. A radiologic technologist or other user of the gonadal shield can hold the handle at a location remote to the patient while positioning the protective cover over the gonads of the patient. The gonadal shield can have a radiopaque indicator spaced from the protective cover configured to allow the user to easily indicate the position of the patient and/or the identity of the radiologic technologist on the x-ray.

This application is a non-provisional of, and claims priority to, U.S. Provisional Application No. 61/782,289, filed Mar. 14, 2013, which is hereby incorporated by reference in its entirety.

### FIELD

1. Field

Provided are gonadal shields and methods of using the same. More particularly, gonadal shields are provided having a handle for use in positioning a gonadal shield.

2. Background

A problem in diagnostic radiology is shielding the gonads (the ovaries and the testes) from the ionizing radiation of x-rays. Shielding the gonads is important because irradiation of the gonads leads to genetic and/or somatic implications.

Typically, prior to taking an x-ray, a radiologic technologist can position a conventional gonadal shield over the gonads of a patient. The conventional gonadal shield can be held in place by taping the shield to the patient, or by attaching the conventional shield to belts, waist rings, and/or hook-and-loop (such as VELCRO) straps that can be worn by the patient. However, if the patient moves, the conventional shield can shift from the desired location. Furthermore, conventional shields can be positioned incorrectly and/or be moved from the desired location by a radiologic technologist uncomfortable with physically palpating the gonadal region of the patient. These deficiencies can be made worse when the patient is an infant or child that has difficulty staying still.

Conventional shields that are held in place by belts, waist rings, and/or straps worn by the patient can often cause an artifact on the x-ray image. Often, this artifact can cover the anatomy of interest requiring the radiologic technologist to take another x-ray again exposing the patient to irradiating x-rays.

In view of the preceding, there is a need in the art for a gonadal shield that can be positioned and maintained in a desired location relative to a patient regardless of the position of the patient without requiring mechanical fasteners to hold the gonadal shield in place, and without requiring physical contact between the radiologic technologist and the patient.

### SUMMARY

Described herein are gonadal shields having a handle for use in shielding radiation from a patient, and more particularly, shielding at least a portion of radiation emitted during an x-ray procedure from the gonads of the patient.

In one aspect, the gonadal shield comprises a protective shield and an elongate handle. The protective cover has a front surface and an opposed rear surface. In another aspect, at least a portion of the rear surface of the protective cover forms a concave curve. In still another aspect, at least a portion of the protective cover comprises a radiopaque material such as, for example and without limitation, lead.

The elongate handle has a proximal end operably coupled or attached (directly or indirectly, and permanently or removably) to a portion of the protective cover and a distal end spaced at a selected distance from the protective cover. In one aspect, the proximal end can be attached to a portion of the front surface of the protective cover. In another aspect, the proximal end of the handle can be rotatably coupled or attached to a portion of the protective cover such that the handle extends away from the protective cover radially and can be rotated through 360 degrees relative to the protective cover.

In yet another aspect, the gonadal shield can comprise a plate, and the proximal end of the elongate handle can be attached to the plate. The elongate handle can be rotatably attached to the plate, in one aspect. The plate can be removably attached to a portion of the protective cover. Such a removable attachment can include use of hook-and-loop material.

In one aspect, the elongate handle can have an adjustable handle length. That is, the handle can have a length adjustable about and between a first handle length and a second handle length that is greater than the first length. In another aspect, a portion of the handle or the entire handle can be formed from a radiolucent material.

In yet other aspects, a gonadal shield is provided that comprises a protective cover, an elongate handle, and an elongate arm rotatably coupled to at least one of the handle and the protective cover. The gonadal shield can also comprise a radiopaque indicator rotatably coupled to an end of the elongate arm. The radiopaque indicator can comprise a positional indicator and/or a user indicator. The positional indicator can indicate the relative position of the patient (for example and without limitation, the left and right sides of the patient) relative to the protective cover, while the user indicator can identify, for example and without limitation, the radiologic technologist taking the x-ray. In another aspect, the positional and/user indicator(s) can be formed from at least one alphanumeric character, shapes and the like.

According to various aspects, methods are provided for shielding the gonads of a patient during an x-ray procedure. The method can include providing a gonadal shield having a protective cover and an elongate handle attached or operably coupled to the protective cover. The method can include positioning the protective cover over the gonads of the patient and positioning the handle so that a user is positioned a desired distance and orientation way from the patient when the user is holding the handle. The gonadal shield can also include an elongate arm rotatably coupled to at least one of the handle and the protective cover, and at least one radiopaque indicator rotatably coupled to a portion of the elongate arm. The radiopaque indicator can comprise at least one of a positional indicator and a user indicator. The method can further include indicating at least one of the side of the patient and the initials of the user on the at least one radiopaque indicator. The method can also include holding the handle such that the protective cover is positioned over the gonads of the patient while the user is spaced a desired distance from the patient.

In yet other embodiments, the gonadal shield can comprise a plate, wherein the handle can be attached to the plate, and the plate can be attached (such as removably attached) to the protective cover. The method can thus further comprise attaching the plate to a selected portion of the protective cover prior to positioning the protective cover over the gonads of the patient.

Additional advantages will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

These and other features of the embodiments of the invention will become more apparent in the detailed description in which reference is made to the appended drawings wherein:

FIG. 1 is an elevational view of one embodiment of a gonadal shield positioned over the gonads of a patient, the gonadal shield comprising a protective cover and a handle.

FIG. 2 is an elevational view of a gonadal shield positioned over the gonads of a patient, according to one aspect.

FIG. 3 is an elevational view of the protective cover of the gonadal shield of FIG. 2, according to one aspect.

FIG. 4 is a cross-sectional view of the protective cover of FIG. 3 taken along line 4-4.

FIG. 5 is an elevational view of an elliptical gonadal shield positioned over the gonads of a patient, according to one aspect.

FIG. 6 is an elevational view of the protective cover of the gonadal shield of FIG. 5, according to one aspect.

FIG. 7 is an elevational view of a heart-shaped gonadal shield positioned over the gonads of a patient, according to one aspect.

FIG. 8 is an elevational view of the protective cover of the gonadal shield of FIG. 7, according to one aspect.

FIG. 9 is an elevational view of the handle of the gonadal shield of FIG. 1, according to one aspect.

FIG. 10 is a perspective view of the gonadal shield of FIG. 1, according to one aspect. The broken lines indicate some, but not all, of the possible positions of the handle relative to the protective cover.

FIG. 11 is an elevational view of the gonadal shield of FIG. 1, according to one aspect. The broken lines indicate some, but not all, of the possible positions of the handle relative to the protective cover.

FIG. 12 is an elevational view of the gonadal shield of FIG. 1 showing indicators attached to the protective cover by respective elongate arms, according to one aspect. The broken lines indicate some, but not all, of the possible positions of the elongate arms relative to the protective cover.

FIG. 13 is an elevational view of a handle of a gonadal shield, showing an indicator attached to the handle by an elongate arm, according to one aspect. The broken lines indicate some, but not all, of the possible positions of the elongate arm relative to the handle.

FIG. 14 is an elevational view of a handle of a gonadal shield, showing an indicator attached to the handle by at least one elongate arm, with another indicator positioned on the handle, according to one aspect. The broken lines indicate some, but not all, of the possible positions of the elongate arm relative to the handle.

FIG. 15 is an elevational view of a gonadal shield holder having a handle and a base assembly, according to one aspect. The broken lines indicate some, but not all, of the possible positions of the base assembly relative to the handle.

FIG. 16 is an elevational view of a gonadal shield holder having a handle, a base assembly, and elongate arms, showing indicators attached to the base assembly by the elongate arms, according to another aspect. The broken lines indicate some, but not all, of the possible positions of the elongate arms relative to the base assembly.

FIG. 17 is an elevational view of a gonadal shield having an elongate handle and a plate, with elongate arms attached to the plate. The broken lines indicate some, but not all of the possible positions of the elongate arms relative to the plate.

FIGS. 18A-18C show exemplary uses of an elongate handle attached to a protective cover by means of a plate, to form a gonadal shield to protect the gonads of a patient.

### DETAILED DESCRIPTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “an arm” can include two or more such arms unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

A gonadal shield 1 for use in diagnostic radiology is provided, according to various aspects. The gonadal shield can include a protective cover and an elongate handle attached to a portion of the protective cover. Referring to FIG. 1, in one aspect, the gonadal shield can comprise an elongate handle 10 extending from a protective cover 12. In use, described more fully below, a user of the gonadal shield 1, such as a radiologic technologist and the like, can hold the handle 10 to position the protective cover in a desired position relative to a patient 14.

With reference to FIGS. 1-8, in one aspect, the protective cover 12 can have a front surface 16 and an opposed rear surface 18. An outer edge 20 can be formed between the front and rear surfaces. In one aspect, the protective cover can be round, such as the substantially circular protective cover 12 shown in FIG. 1. Optionally, the protective cover 12 can be an elongated rectangular cover having rounded corners when viewed in elevation as illustrated in FIGS. 2-4. In another aspect, the protective cover can be substantially elliptical when viewed in elevation, as illustrated in FIGS. 5 and 6. Optionally, the protective cover 12 can be substantially oval, substantially square, substantially rectangular, substantially triangular, or heart-shaped (as illustrated in FIGS. 7 and 8) when viewed in elevation. In yet other aspects, the protective cover can be a polygon with any number of sides; the corners of the polygon can be sharp or rounded.

In one particular embodiment, the protective cover 12 can have a shape desired to cover the gonads of a male or female patient. For example, and not meant to be limiting, an elongated rectangular cover with rounded corners, such as shown in FIGS. 2-4, can be used with a male patient to cover the testes and penis. Similarly, a heart-shaped protective cover, such as shown in FIGS. 7-8, can be used with a female patient to cover the ovaries. As can be appreciated, the protective cover can be any other shape, and/or can be a combination of shapes, such as other geometric shapes or polygons, or other random shapes or designs.

In another aspect, the protective cover 12 can be at least partially curved when viewed in cross-section. For example, as shown in FIG. 4, the front surface 16 and rear surface 18 of the protective cover can form concave curves, such that the protective cover is curved when viewed in cross-section. That is, when viewed in cross-section and as illustrated in FIG. 4, at least a portion of the protective cover can be substantially “C”-shaped or substantially “U”-shaped. Optionally, at least a portion of the protective cover can be cup-shaped or formed into a dome shape. It is contemplated that, when in use, the curvature or partial curvature of the protective cover can assist in covering or protecting the gonads or other portion of the patient's 14 body.

According to one aspect, the protective cover 12 can have a cross-dimension (such as a diameter or length) of any necessary dimension to adequately cover a desired area of a patient. This cross-dimension can be selected depending on the size of the area to be covered and/or the size and age of the patient. For example, the protective cover 12 for use on an infant or baby can be smaller than the protective cover for use on an adult patient. By way of example, and not meant to be limiting, the protective cover can have a cross-dimension that ranges from less than about 3 inches to greater than about 9 inches. Thus, the cross-dimension can be less than about 3 inches, about 3 inches, about 3.5 inches, about 4 inches, about 4.5 inches, about 5 inches, about 5.5 inches, about 6 inches, about 6.5 inches, about 7 inches, about 7.5 inches, about 8 inches, about 8.5 inches, about 9 inches, or greater than about 9 inches. It is contemplated, however, that the protective cover can be formed from other shapes and/or sizes as necessary to cover the gonadal area of different shaped and sized patients.

According to other aspects, the protective cover can be provided to a user in a number of pre-determined sizes and shapes, thereby allowing the user to select the desired size and shape depending on the size of the patient. For example, for a substantially circular protective cover, pre-sized protective covers can have diameters of about 4 inches, about 6 inches, and about 8 inches. Similarly, for an elliptical or heart-shaped protective cover, the pre-sized protective covers can have cross-dimensions of about 4 inches, about 6 inches, and about 8 inches. For an elongated, rounded rectangular protective cover (such as shown in FIGS. 2-4), the protective cover can come in varying sizes, such as but not limited to about 3.5 inches wide by about 5 inches in length, or about 5.5 inches wide by about 8 inches in length.

At least a portion of the protective cover can comprise a radiopaque material such as, for example and without limitation, lead. In one aspect, the thickness of the radiopaque material can be at least 0.5 millimeters thick. Such a thickness attenuates approximately 99% of a 50-kVp beam, approximately 88% of a 75-kVp beam, and 75% of a 100-kVp beam. The thickness can, of course, vary, depending on the attenuation needs of the beam used in a particular x-ray application. In another aspect, the radiopaque material can be covered with a polymeric material such as rubber, nylon and the like. For example, the polymeric material can be tear-resistant nylon material. The polymeric material can also be available in a predetermined range of colors. According to various aspects, the protective cover can be disposable. Such a disposable protective cover can comprise lead. In other embodiments, it can comprise a non-lead material such as tungsten and/or antimony.

With reference now to FIGS. 9-14, the handle 10 can be an elongate handle configured to extend from the protective cover 12. In one aspect, the handle can have a proximal end 26, an opposed distal end 28, and a handle length extending from the proximal end to the distal end. The length can have any length, such as a length of less than 8 inches to greater than 20 inches. For example, the length of the handle 10 can be less than about 8 inches, about 8 inches, about 9 inches, about 10 inches, about 11 inches, about 12 inches, about 13 inches, about 14 inches, about 15 inches, about 16 inches, about 17 inches, about 18 inches, about 19 inches, about 20 inches, or greater than about 20 inches. In another aspect, at least a portion of the handle can have a handle diameter of less than about 0.25 inches, about 0.25 inches, about 0.50 inches, about 0.75 inches, about 1 inch, or greater than about 1 inch.

In another aspect, the handle 10 can be an adjustable handle having a length adjustable about and between a first length and a second length. In this aspect, the second length can be greater than the first length. Thus, the handle can be both extendable and collapsible. For example, the handle 10 can be a telescoping handle so that at least a portion of a first section 22 of the handle can be positioned inside of a second section 24 of the handle when the length of the handle is the first length. In this manner, the handle can be adjusted from a first length, such as less than about 8 inches, to a second length, such as greater than about 20 inches, or any length therebetween. In another example, the handle can be adjusted from a first length of about 10 inches to a second length of about 15 inches.

In one aspect, the handle can include a switch 50 or other locking mechanism that allows the handle to be extended or collapsed, such as shown in FIGS. 11 and 12. The switch can be disengaged to allow the handle to be extended or collapsed, and then engaged to lock the handle at the user's desired length.

In one aspect, at least a portion of the handle 10 can be formed from a radiolucent material such as wood, polymeric materials, plastics and the like. For example, the handle can be formed from a plastic that does not prevent x-rays from passing through the handle 10.

In one aspect, a portion of the handle 10 can be attached to a portion of the protective cover 12. The handle can be attached directly or indirectly to the protective cover. In other embodiments, the handle can be attached permanently or removably to the protective cover. Thus, the attachment between the handle and the protective cover can be any form of operative coupling therebetween.

According to various embodiments, the proximal end 26 of the handle 10 can be attached to a portion of the protective cover 12. As illustrated in FIGS. 10 and 11, the proximal end 26 of the handle can be attached to a portion of the front surface 16 of the protective cover. Alternatively, the proximal end of the handle 10 can be attached to a portion of the rear surface 18 or the outer edge 20 of the protective cover 12. In another aspect, the handle can be attached to the protective cover so that the handle 10 extends away from the protective cover 12 radially as illustrated in FIG. 11. Optionally, the handle can be attached to the protective cover so that the handle 10 extends away from the protective cover 12 radially, axially or some combination of radially and axially.

In one aspect, the handle 10 can be removably attached to the protective cover 12. For example, the handle can be attached to the protective cover with the use of hook-and-loop material, such as VELCRO fasteners. As can be appreciated, a portion of the protective cover can have either the hook or loop material on it. Optionally, substantially all of the protective cover can be covered with hook or loop material. In yet another embodiment, the protective cover can be partially or wholly covered in a material to which loops can attach. Thus, as can be appreciated, a portion of the proximal end of the handle can include a corresponding hook or loop material to allow it to removably attach to the protective cover.

In various aspects, the handle 10 can be rotatably attached to a portion of the protective cover 12. In another aspect, the handle can be coupled to the protective cover so that the handle 10 can be rotated 360 degrees relative to the protective cover 12. For example, when viewed in elevation as in FIG. 11, the protective cover can be coupled to the handle by a swivel so that the handle can 12 be rotated to any position through about 360 degrees. It can also be understood that such rotatable movement is not meant to be limited to movement within one plane. Thus, the handle can be moved within a three-dimensional space relative to the protective cover, due to its rotatable and/or axial attachment to the protective cover.

In other embodiments, such as shown in FIG. 17, the gonadal shield can further comprise a plate 270. The elongate handle 210 can have a proximal end 226 rotatably attached to the plate 270, which can, in turn, be attached to the protective cover 12. Thus, the handle can be attached to the protective cover by means of the plate, thereby providing operative coupling between the handle 210 and the protective cover 12. As described above, in some aspects, the handle 210 can be removably attached to the protective cover 12 by means of hook-and-loop fastener material. In this embodiment, it is contemplated that at least a portion of the plate 270 can be covered in hook or loop material. For example, as shown in FIG. 17, a strip 272 of hook (or loop) material can be placed on the surface of the plate 270 that will be attached to the protective cover. Optionally, substantially the entire attaching surface of the plate can be covered in hook (or loop) material. Similarly, and as described above, at least a portion of the protective cover 12 can be covered in corresponding loop or hook material. Thus, the plate can be selectively placed on the protective cover in a desired position. Because of the removable attachment between the plate and protective cover, the handle 210 (and plate 270) can be detached from the protective cover 12 after use. The protective cover 12 can then be detached for cleaning and/or disposal.

According to this embodiment, the plate 270 can be made of a radiolucent material, such as, but not limited to, wood, polymeric materials, plastics and the like. In one particular embodiment, the elongate handle 210 can be made from the same radiolucent material as the plate 270; optionally, the handle can be made from a different radiolucent as the plate.

Similarly to the handle 10 described above, the handle 210 shown in FIGS. 17 and 18A-C can be adjustable in length. The gonadal shield shown in FIG. 17 can also include at least one elongate arm 32, as described above, which includes an indicator 30 (described below) at a distal end thereof The indicator 30 can include a positional indicator and/or user indicator as described herein.

Although shown in the figures as being rectangular, it is contemplated that the plate 270 can be any desired shape to allow it to attach to the protective cover. The plate can also be of any dimensions that enable it to be connected to the protective cover. In one aspect, the plate can be extendable in length to allow it to vary in size, as needed for the particular use. For example, the plate can be extendable from a first length of about 5 inches to a second length of about 10 inches. Other ranges are, of course, contemplated.

Exemplary uses of a gonadal shield having a handle that includes a plate 270 used to attach the handle 210 to the protective cover 12 are shown in FIGS. 18A-18C. As can be seen, the plate 270 (which is attached to the handle) can be attached to the protective cover 12, and placed over the gonads of the patient prior to an x-ray being taken. FIG. 18A shows, for example, a gonadal shield in use with a female patient. Because of the removable attachment between the plate 270 and the protective cover 12, the protective cover 12 can be rotated to adequately shield the gonads of a female patient. Similarly, the protective cover can be detached, rotated, and reattached to the protective cover to adequately shield the gonads of a male patient (such as shown in FIG. 18B). FIG. 18C shows the gonadal shield in use with infant patients. In other embodiments, the attachment between the handle and the plate can be a rotatable attachment, such that once the plate has been attached to the protective cover, the plate and protective cover can be rotated relative to the handle, allowing the handle to be rotated or oriented to a desired position for a user.

As can be appreciated, the handle shown in FIGS. 18A-18C can include elongate arms 32 and indicators 30 such as shown in FIG. 12 or FIG. 17. Optionally, the handle can include at least one indicator (30a and/or 30b) that can be coupled directly to the handle (such as shown in FIG. 14, described further herein below).

In one aspect, the gonadal shield 1 can further comprise at least one indicator. In this aspect, the at least one indicator can be a radiopaque indicator attached directly to the handle 10 and/or the protective cover 12. Alternatively, the at least one indicator can be a radiopaque indicator spaced from the handle or protective cover by at least one elongate arm 32. As seen in FIGS. 11-14, in another aspect, the at least one indicator can be a positional indicator 30a for identifying the left and/or right sides of the patient on the x-ray. In this aspect, the positional indicator can comprise alphanumeric characters, such as ‘L’, ‘R’ and the like. The positional indicator 30a can optionally comprise shapes such as a square, triangle, circle, arrow and the like that could be used to convey a position. In still another aspect, the at least one indicator can be a user indicator 30b for identifying the user, such as the radiologic technologist. In this aspect, the user indicator 30b can comprise alphanumeric characters to form an identifying name or number, such as, for example and without limitation, user initials, an employee ID number, or another unique user ID. In a further aspect, the at least one indicator can comprise both a positional indicator 30a and a user indicator 30b.

In one aspect, the at least one indicator can be positioned in a predetermined location relative to the cover 12. For example, the indicator can be a positional indicator 30a configured to hold the letter ‘L’ on the left side of the patient, thereby indicating the left side of the patient on the x-ray, and/or the letter ‘R’ on the right side of the patient, thereby indicating the right side of the patient on the x-ray.

In one aspect, the at least one indicator can be rotatable so that the at least one indicator can be rotated to a desired orientation. For example, if the protective cover 12 and/or handle 10 were at an acute angle relative to the longitudinal axis of the patient, the at least one indicator can be rotated so that the at least one indicator is held upright and would be easily legible on the x-ray regardless of the position of the protective cover and/or handle.

In one aspect, the at least one indicator can comprise a plurality of indicators. In this aspect, at least one indicator of the plurality of indicators can be can be a positional indicator 30a configured to hold at least one radiopaque alphanumeric character or shape indicating the position of the patient relative to the protective cover 12, and/or at least one indicator of the plurality of indicators can be a user indicator 30b configured to hold at least one radiopaque alphanumeric character or shape identifying the radiologic technologist in a predetermined position relative to the protective cover.

In one aspect, the at least one indicator (30a and/or 30b) can be coupled directly to the handle 10 (as shown in FIG. 14) or the protective cover 12 (as shown in FIG. 12). Alternatively, in another aspect, the gonadal shield can further comprise the at least one elongate arm 32, such as shown in FIGS. 12-14. In this aspect, a first end 36 of the at least one elongate arm can be coupled to the handle 10 or the protective cover 12, and a second end 38 of the at least one elongate arm can be coupled to the at least one indicator (30a and/or 30b). In another aspect, the at least one elongate arm 32 can be formed from a radiolucent material.

In one aspect, the at least one elongate arm can 32 be an elongate arm configured to position the at least one indicator a predetermined distance from the protective cover 12. For example, the at least one elongate arm 32 can extend from a portion of the protective cover or the handle 10 a predetermined distance so that the at least one indicator (30a and/or 30b) is spaced from the cover, as illustrated in FIG. 12, for example. In this way, on an x-ray, the radiopaque cover 12 would be visible and the at least one indicator would be visible and spaced from the cover.

In another aspect, the first end 36 of the at least one elongate arm 32 can be rotatably coupled to the handle 10 or the protective cover 12 so that the at least one indicator coupled to the second end 38 of the at least one elongate arm can be rotated to a desired position relative to the handle and/or the protective cover. For example and as illustrated in FIGS. 12-14, the first end of the at least one elongate arm 32 can be attached to a swivel 40 or pivot point that allows the at least one elongate arm 32 to rotate relative to the protective cover or the handle.

The at least one indicator 30 can further comprise at least one indicator wheel 42, according to one aspect. For example, the at least one indicator wheel can be a device having alphanumeric characters such as the letters A-Z and/or the numbers 0-9 positioned on a face of a rotatable wheel such that a user of the indicator wheel 42 can rotate the wheel until a desired character is indicated. In another aspect, if the at least one indicator 30 comprises a plurality of indicators, the plurality of indicators can respectively comprise a plurality of indicator wheels. For example, three indicator wheels 42 can be positioned adjacent to each other on a user indicator 30b so that a user of the device, such as a radiologic technologist, could rotate each wheel so that the user's initials are indicated on the wheels.

In yet another aspect, the at least one elongate arm 32 can be an adjustable handle having a length adjustable about and between a first length and a second length, such as described above with respect to the handle 10. In this aspect, the second length can be greater than the first length. Thus, the arm can be both extendable and collapsible. For example, the at least one elongate arm 32 can be a telescoping arm so that at least a portion of a first section of the arm can be positioned inside of a second section of the arm when the length of the arm is the first length. As described above with respect to the handle, the arm can have a switch or other locking mechanism 52 (shown in FIG. 14) that allows the arm to be extended or collapsed. The switch can be disengaged to allow the arm to be extended or collapsed, and then engaged to lock the arm at the user's desired length.

In yet another aspect, a gonadal shield holder 100 can be provided for use with any protective cover, such as shown in FIGS. 15-16. The gonadal shield holder 100 can include a handle 110, such as the handles 10 previously described herein, and a base assembly 160. The base assembly 160 can comprise an extendable/collapsible member 162 having a first end and an opposed second end, with clips 164 or other attachment means (such as hook-and-loop fasteners) mounted at the first and second ends. The base assembly can be rotatably mounted to the handle at a pivot point 140, thereby allowing the base assembly to rotate with respect to the handle. The clips 164 can also be rotatably mounted to the ends of the member 162, to allow them to rotate to any position with respect to the member 162. In this manner, the clips 164 can attach to opposing ends or sides of a protective cover. By virtue of being extendable or collapsible, the base assembly can be adjusted to a desired length to accommodate any size or shape of protective cover. A switch 150 can be provided on the handle (as shown in FIGS. 15-16) or the member 162 of the base assembly (not shown) to lock the position of the base assembly relative to the handle. For example, the member 162 can be rotated with respect to the handle (or vice versa), and the switch 150 can be engaged to lock the member 162 at the desired rotational position. A separate switch can also be provided on the member 162 to lock the member 162 at the desired length.

As can be appreciated, the clips 164 or other attachment means can be radiolucent. In other aspects, at least one elongate arm 132 can be rotatably attached to the base assembly, such that they can be selectively positionable by a user. Indicators can be positioned at the distal ends of the elongate arms, such as positional indicators 30a, and/or user indicators 30b, such as those described above.

In order to use the gonadal shield 1, a user of the device, such as a radiologic technologist, can select a gonadal shield having a protective cover 12 sized and/or shaped to cover the gonads of the patient. For example, the protective cover for use on a premature baby would be smaller than the protective cover 12 for use on an adult patient. As another example, the user can select a protective cover 12 shaped to cover the gonads of a particular patient (such as, not limited to, a heart-shaped protective cover for a female patient).

The user can rotate and/or extend the handle 10 of the gonadal shield so that the user is positioned a desired distance and/or orientation away from the patient when the user is holding the handle and the protective cover is positioned over the gonads of the patient. For example, depending on at least the layout of the room and/or the direction of travel of the x-rays, the user can rotate and/or extend the handle to minimize the user's exposure to the x-rays emitted.

Optionally, the user can use the at least one indicator (30a and/or 30b) to indicate at least one of the position of the patient and the initials (or other identifier) of the user. For example, the user can place an alphanumeric character such as letter “L” and/or “R” in a desired position relative to the protective cover to indicate the left and/or right sides of the patient on the x-ray. In another example, the user can rotate the at least one indicator wheel to indicate a desired character or plurality of characters. In still another example, the user can rotate and/or extend or collapse the at least one arm 32 to a desired position so that the at least one indicator is in a desired position relative to the handle 10 and/or the protective cover 12.

The user can then hold the handle 10 of the gonadal shield 1 so that the protective cover 12 is positioned over the gonads of the patient while the user is spaced a desired distance from the patient. Upon taking the x-ray, the gonads of the patient will be at least partially shielded from the radiation, and any indicators selected by the user will appear on the x-ray.

Optionally, a user can use the gonadal shield holder 100, shown in FIGS. 15 and 16, with any protective cover. The user can adjust the member 162 to a desired length, and rotate the clips 164 and clip them onto opposing sides of the protective cover. The user can use one or more switches to lock in the length of the member. The user can then rotate the handle 110 to a desired position and use switch 150 to lock in the rotational position of the member relative to the handle. As described above, the user can optionally rotate and/or position elongate arms 32 relative to the base assembly 160, and can use the at least one indicator (30a and/or 30b) to indicate at least one of the position of the patient and the initials (or other identifier) of the user.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A gonadal shield comprising:
a protective cover having a front surface and an opposed rear surface, wherein the protective cover comprises a radiopaque material; and
an elongate handle having a proximal end attached to a portion of the protective cover, and an opposed distal end spaced at a selected distance from the protective cover.

2. The gonadal shield of claim 1, wherein at least a portion of the rear surface forms a concave curve.

3. The gonadal shield of claim 1, wherein the radiopaque material is lead.

4. The gonadal shield of claim 1, wherein the proximal end of the elongate handle is rotatably attached to the front surface of the protective cover.

5. The gonadal shield of claim 1, wherein at least a portion of the elongate handle is formed from a radiolucent material.

6. The gonadal shield of claim 1, wherein the elongate handle has a handle length that is adjustable about and between a first handle length and a second handle length that is greater than the first handle length.

7. The gonadal shield of claim 1, wherein the proximal end of the elongate handle is rotatably attached to a portion of the protective cover such that the elongate handle can be rotated through about 360 degrees relative to the protective cover.

8. The gonadal shield of claim 1, further comprising at least one radiopaque indicator spaced from the protective cover, wherein the at least one radiopaque indicator comprises at least one of a positional indicator and a user indicator.

9. The gonadal shield of claim 8, wherein the at least one radiopaque indicator is spaced from the protective cover by at least one elongate arm.

10. The gonadal shield of claim 9, wherein a first end of the at least one elongate arm is coupled to at least one of the handle and the protective cover, and a second end of the at least one elongate arm is coupled to the at least one radiopaque indicator.

11. A gonadal shield comprising:
a protective cover having a front surface and an opposed rear surface, wherein the protective cover comprises a radiopaque material, and wherein at least a portion of the rear surface forms a concave curve;
an elongate handle having a proximal end rotatably attached to a portion of the front surface of the protective cover, and a distal end extending away from the protective cover, wherein at least a portion of the elongate handle is formed from a radiolucent material;
an elongate arm having a first end and a second end, wherein the first end is rotatably coupled to at least one of the handle and the protective cover; and
at least one radiopaque indicator rotatably coupled to the second end of the at least one elongate arm, wherein the at least one radiopaque indicator comprises at least one of a positional indicator and a user indicator, wherein the positional indicator indicates at least the position of the patient relative to the protective cover and comprises at least one alphanumeric character, and wherein the user indicator identifies at least a user of the gonadal shield and comprises at least one alphanumeric character.

12. The gonadal shield of claim 11, wherein the radiopaque material is lead.

13. The gonadal shield of claim 11, wherein the elongate handle has a handle length that is adjustable about and between a first handle length and a second handle length that is greater than the first handle length.

14. The gonadal shield of claim 11, wherein the proximal end of the elongate handle is rotatably attached to a portion of the protective cover such that the elongate handle can be rotated about 360 degrees relative to the protective cover.

15. The gonadal shield of claim 11, wherein the protective cover has a shape selected from the group consisting of a circle, an ellipse, an oval, a polygon, and a heart.

16. A method of shielding the gonads of a patient during an x-ray procedure, the method comprising:
providing a gonadal shield comprising:
a protective cover having a front surface and an opposed rear surface, wherein the protective cover comprises a radiopaque material;
an elongate handle having a proximal end rotatably attached to a portion of the protective cover, and a distal end extending away from the protective cover;
an elongate arm having a first end and a second end, wherein the first end is rotatably coupled to at least one of the handle and the protective cover; and
at least one radiopaque indicator rotatably coupled to the second end of the at least one elongate arm, wherein the at least one radiopaque indicator comprises at least one of a positional indicator and a user indicator, wherein the positional indicator indicates at least the position of the patient relative to the protective cover and comprises at least one alphanumeric character, and wherein the user indicator identifies at least a user of the gonadal shield and comprises at least one alphanumeric character;
positioning the elongate handle so that the user is positioned a desired distance and/or orientation away from the patient when the user is holding the handle and the protective cover is positioned over the gonads of the patient;
indicating at least one of the side of the patient and the initials of the user on the at least one radiopaque indicator;
holding the handle such that the protective cover is positioned over the gonads of the patient while the user is spaced a desired distance from the patient.

17. The method of claim 16, further comprising taking an x-ray of at least a portion of the patient after the step of holding the handle such that the protective cover is positioned over the gonads of the patient.

18. The method of claim 16, wherein positioning the elongate handle comprises rotating the handle so that the user is positioned a desired distance and/or orientation away from the patient.

19. The method of claim 16, wherein positioning the elongate handle comprises adjusting the length of the handle so that the user is positioned a desired distance and/or orientation away from the patient.

20. The method of claim 16, wherein positioning the handle comprises rotating the handle and adjusting the length of the handle so that the user is positioned a desired distance and/or orientation away from the patient.
